(19) United States
(12) Patent Application Publication
(10) Pub. No.: US 2023/0115588 A1
(43) Pub. Date: Apr. 13, 2023

(54) SHEET MOLDING COMPOUND REINFORCED WITH GRAPHENE FLAKES, AND METHODS OF PRODUCING THE SAME

(71) Applicant: NanoXplore Inc., Montreal (CA)

(72) Inventors: Nima MOGHIMIAN, Saint Laurent (CA); Soroush NAZARPOUR, Saint-Laurent (CA)

(21) Appl. No.: 17/964,385

(22) Filed: Oct. 12, 2022

Related U.S. Application Data
(60) Provisional application No. 63/255,135, filed on Oct. 13, 2021.

(51) Int. Cl. C08K 13/04; C08J 3/20; B29C 70/02

(52) U.S. Cl. CPC C08K 13/04; B29C 70/025; C08J 3/203; C08K 7/14; C08K 2201/014

(57) ABSTRACT

Embodiments described herein can include a composition comprising a thermoset resin with a plurality of graphene flakes dispersed therein, each of the plurality of graphene flakes having a lateral dimension and a thickness. The composition further comprises a reinforcement material dispersed in the thermoset resin. At least about 90% of the plurality of graphene flakes are oriented such that the lateral dimension is within about 10 degrees of a parallel alignment with a horizontal plane. In some embodiments, at least about 95%, or at least about 99% of the plurality of graphene flakes are oriented such that the lateral dimension is within about 10 degrees of a parallel alignment with the horizontal plane. In some embodiments, the reinforcement material can include at least one of a plurality of fibers or a plurality of beads.

### CROSS-REFERENCE TO RELATED APPLICATIONS

This application claims priority to and the benefit of U.S. Provisional Pat. Application No. 63/255,135, filed Oct. 13, 2021, entitled “Sheet Molding Compound Reinforced with Graphene Flakes, and Methods of Producing the Same,” the disclosure of which is hereby incorporated by reference in its entirety.

### TECHNICAL FIELD

Embodiments described herein relate to sheet molding compound reinforced with graphene flakes, and methods of producing the same.

### BACKGROUND

Sheet molding compound (SMC) is a reinforced composite material primarily made by compression molding with many applications, including the automotive industry, electrical appliances, agricultural machinery (e.g., combines, tractors), mining machinery (e.g., excavators, track loaders), and building materials. The SMC material can act as a liquid during the formation process and as a solid once the formation process is complete. Advantages of SMC include ease of manufacture, high rate of production, good reproducibility of parts formed via SMC, and cost effectiveness. While SMC performs well in most applications, its mechanical properties (e.g., tensile strength, impact resistance, flexural strength, etc.) and surface properties have significant room for improvement.

### SUMMARY

Embodiments described herein can include a composition comprising a thermoset resin with a plurality of graphene flakes dispersed therein, each of the plurality of graphene flakes having a lateral dimension and a thickness. The composition further comprises reinforcement material dispersed in the thermoset resin. In some embodiments, the reinforcement material can include at least one of a plurality of reinforcement fibers or a plurality of beads. At least about 90% of the plurality of graphene flakes are oriented such that the lateral dimension is within about 10 degrees of a parallel alignment with a horizontal plane. In some embodiments, at least about 95%, or at least about 99% of the plurality of graphene flakes are oriented such that the lateral dimension is within about 10 degrees of a parallel alignment with the horizontal plane. In some embodiments, the reinforcement material includes a plurality of fibers and at least about 90% of the plurality of fibers are aligned such that the lateral dimension is within about 10 degrees of a parallel alignment with the horizontal plane. In some embodiments, the reinforcement material can include glass fiber, glass beads, glass hollow bubbles, carbon fiber, metallic fibers, polymer fibers, polyester fibers, Kevlar, and/or nylon. In some embodiments, the thermoset resin can include a polyester resin, a vinyl ester resin, and/or an epoxy resin. In some embodiments, the composition can be formed into a slab of material, the slab of material having a thickness of less than about 2 cm. In some embodiments, the slab of material can have a tensile strength of at least about 64 MPa. In some embodiments, the composition can include a mineral filler. In some embodiments, the mineral filler can include calcium carbonate (CaCO₃). In some embodiments, the composition can include a mold release agent. In some embodiments, the mold release agent can include a fatty acid salt. In some embodiments, the composition can include a low profile additive. In some embodiments, the low profile additive can include thermoplastics particles incorporated into an unsaturated polyester resin.

### BRIEF DESCRIPTION OF THE DRAWINGS

FIG. 1 is a block diagram of a sheet molding compound, according to an embodiment.

FIG. 2 is an illustration of sheet molding compound, according to an embodiment.

FIG. 3 is a block diagram of a method of a method of producing a sheet molding compound, according to an embodiment.

FIGS. 4A-4B illustrate a process of pressing a sheet molding compound, according to an embodiment.

FIG. 5 is a block diagram of a method of a method of producing a sheet molding compound, according to an embodiment.

FIGS. 6A-6B illustrate a process of pressing a sheet molding compound, according to an embodiment.

FIG. 7 shows mechanical strength data of sheet molding compounds with and without graphene reinforcement.

### DETAILED DESCRIPTION

Embodiments described herein relate to SMC reinforced with graphene flakes, and methods of producing the same. While SMC performs well and has many positive physical attributes, its mechanical strength properties have room for improvement. Incorporation of graphene flakes into SMC can improve mechanical and flexural strength of the SMC. Mechanical properties of the SMC can be further improved by properly aligning the graphene flakes. Mechanical improvements brought on via reinforcement by graphene flakes are more significant when the graphene flakes are oriented parallel or substantially parallel to one another.

Graphene flakes incorporated into the SMC can have a wide range of physical properties. In some embodiments, at least a portion of the graphene flakes can be freely suspended in the SMC, such that the graphene flakes do not have significant van der Waal’s forces on nearby graphene flakes. In some embodiments, at least a portion of the graphene flakes can be agglomerated, such that they exert significant van der Waal’s forces on one another. In some embodiments, the graphene flakes can have any of the physical properties of the graphene flakes described in U.S. Pat. 9,469,542 (“the ‘542 patent”), filed Dec. 22, 2015, and entitled, “Large Scale Production of Thinned Graphite, Graphene, and Graphite-Graphene Composites,” the entire disclosure of which is hereby incorporated by reference.

As used herein, the term “crystalline graphite” or “precursor crystalline graphite” refers to graphite based material of a crystalline structure with a size configured to allow ball milling in a ball milling jar. For example, the crystalline graphite can be layered graphene sheets with or without defects, such defects comprising vacancies, interstitials, line defects, etc. The crystalline graphite may come in diverse forms, such as but not limited to ordered graphite including natural crystalline graphite, pyrolytic graphite (e.g., highly ordered pyrolytic graphite (HOPG)), graphite fiber, graphite rods, graphite minerals, graphite powder, flake graphite, any graphitic material modified physically and/or chemically to be crystalline, and/or the like. As another example, the crystalline graphite can be graphite oxide.

As used herein, the term “thinned graphite” refers to crystalline graphite that has had its thickness reduced to a thickness from about a single layer of graphene to about 1,200 layers, which is roughly equivalent to about 400 nm. As such, single layer graphene sheets, few-layer graphene (FLG) sheets, and in general multi-layer graphene sheets with a number of layers about equal to or less than 1,200 graphene layers can be referred as thinned graphite.

As used herein, the term “few-layer graphene” (FLG) refers to crystalline graphite that has a thickness from about 1 graphene layer to about 10 graphene layers.

As used herein, the term “lateral size” or “lateral sheet size” relates to the in-plane linear dimension of a crystalline material. For example, the linear dimension can be a radius, diameters, width, length, diagonal, etc., if the in-plane shape of the material can be at least approximated as a regular geometrical object (e.g., circle, square, etc.). If the in-plane shape of the material can not be modeled by regular geometrical objects relatively accurately, the linear dimension can be expressed by characteristic parameters as is known in the art (e.g., by using shape or form factors).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

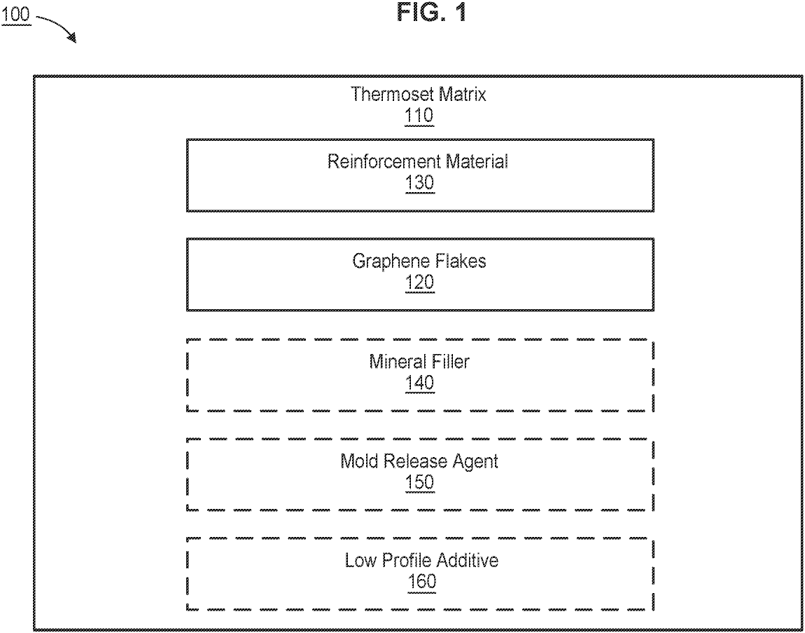

FIG. 1 shows a block diagram of a sheet molding compound (SMC) 100, according to an embodiment. As shown, the SMC 100 includes a thermoset matrix 110 with graphene flakes 120 and reinforcement material 130 dispersed therein. The SMC 100 optionally includes a mineral filler 140 and/or a mold release agent 150. In some embodiments, the thermoset matrix 110 can include a polyester resin, a urethane, a silicone, a cyanoacrylate, an acrylic, a phenolic, an unsaturated ester, a vinyl ester resin, an epoxy resin, or any combination thereof. In some embodiments, the thermoset matrix 110 can flow like a liquid (prior to curing) when subjected to significant pressure.

The graphene flakes 120 are dispersed in the thermoset matrix 110 and can aid in improving the mechanical properties of the SMC 100 and components formed therefrom. In some embodiments, the graphene flakes 120 can reduce the moisture absorption of the SMC 100. Reduced absorption leads to reduced blistering and reduced waviness or warping on the surface of a component formed from the SMC 100, thereby making the component easier to paint. In some embodiments, the graphene flakes 120 can have a concentration in the SMC 100 of at least about 0.1 wt%, at least about 0.2 wt%, at least about 0.3 wt%, at least about 0.4 wt%, at least about 0.5 wt%, at least about 0.6 wt%, at least about 0.7 wt%, at least about 0.8 wt%, at least about 0.9 wt%, at least about 1 wt%, at least about 1.5 wt%, at least about 2 wt%, at least about 2.5 wt%, at least about 3 wt%, at least about 3.5 wt%, at least about 4 wt%, at least about 4.5 wt%, at least about 5 wt%, at least about 5.5 wt%, at least about 6 wt%, at least about 6.5 wt%, at least about 7 wt%, at least about 7.5 wt%, at least about 8 wt%, at least about 8.5 wt%, at least about 9 wt%, or at least about 9.5 wt%. In some embodiments, the graphene flakes 120 can have a concentration in the SMC 100 of no more than about 10 wt%, no more than about 9.5 wt%, no more than about 9 wt%, no more than about 8.5 wt%, no more than about 8 wt%, no more than about 7.5 wt%, no more than about 7 wt%, no more than about 6.5 wt%, no more than about 6 wt%, no more than about 5.5 wt%, no more than about 5 wt%, no more than about 4.5 wt%, no more than about 4 wt%, no more than about 3.5 wt%, no more than about 3 wt%, no more than about 2.5 wt%, no more than about 2 wt%, no more than about 1.5 wt%, no more than about 1 wt%, no more than about 0.9 wt%, no more than about 0.8 wt%, no more than about 0.7 wt%, no more than about 0.6 wt%, no more than about 0.5 wt%, no more than about 0.4 wt%, no more than about 0.3 wt%, or no more than about 0.2 wt%.

Combinations of the above-referenced concentrations of the graphene flakes 120 in the SMC 100 are also possible (e.g., at least about 0.1 wt% and no more than about 10 wt% or at least about 0.3 wt% and no more than about 3 wt%), inclusive of all values and ranges therebetween. In some embodiments, the graphene flakes 120 can have a concentration in the SMC 100 of about 0.1 wt%, about 0.2 wt%, about 0.3 wt%, about 0.4 wt%, about 0.5 wt%, about 0.6 wt%, about 0.7 wt%, about 0.8 wt%, about 0.9 wt%, about 1 wt%, about 1.5 wt%, about 2 wt%, about 2.5 wt%, about 3 wt%, about 3.5 wt%, about 4 wt%, about 4.5 wt%, about 5 wt%, about 5.5 wt%, about 6 wt%, about 6.5 wt%, about 7 wt%, about 7.5 wt%, about 8 wt%, about 8.5 wt%, about 9 wt%, about 9.5 wt%, or about 10 wt%.

In some embodiments, the graphene flakes 120 can have any of the physical properties of the graphene flakes described in the ‘542 patent. In some embodiments, the graphene flakes 120 can have a lateral dimension of at least about 10 nm, at least about 50 nm, at least about 100 nm, at least about 500 nm, at least about 1 µm, at least about 5 µm, at least about 10 µm, at least about 50 µm, at least about 100 µm, at least about 200 µm, at least about 300 µm, at least about 400 µm, at least about 500 µm, at least about 600 µm, or at least about 700 µm. In some embodiments, the graphene flakes 120 can have a lateral dimension of no more than about 800 µm, no more than about 700 µm, no more than about 600 µm, no more than about 500 µm, no more than about 400 µm, no more than about 300 µm, no more than about 200 µm, no more than about 100 µm, no more than about 50 µm, no more than about 10 µm, no more than about 5 µm, no more than about 1 µm, no more than about 500 nm, no more than about 100 nm, or no more than about 50 nm. Combinations of the above-referenced lateral dimensions of the graphene flakes 120 are also possible (e.g., at least about 10 nm and no more than about 800 µm or at least about 10 µm and no more than about 500 µm), inclusive of all values and ranges therebetween. In some embodiments, the graphene flakes 120 can have a lateral dimension of about 10 nm, about 50 nm, about 100 nm, about 500 nm, about 1 µm, about 5 µm, about 10 µm, about 50 µm, about 100 µm, about 200 µm, about 300 µm, about 400 µm, about 500 µm, about 600 µm, about 700 µm, or about 800 µm.

In some embodiments, the graphene flakes 120 can have a thickness of at least about 1 graphene layer, at least about 2 graphene layers, at least about 3 graphene layers, at least about 4 graphene layers, at least about 5 graphene layers, at least about 6 graphene layers, at least about 7 graphene layers, at least about 8 graphene layers, at least about 9 graphene layers, at least about 10 graphene layers, at least about 11 graphene layers, at least about 12 graphene layers, at least about 13 graphene layers, at least about 14 graphene layers, at least about 15 graphene layers, at least about 16 graphene layers, at least about 17 graphene layers, at least about 18 graphene layers, or at least about 19 graphene layers. In some embodiments, the graphene flakes 120 can have a thickness of no more than about 20 graphene layers, no more than about 19 graphene layers, no more than about 18 graphene layers, no more than about 17 graphene layers, no more than about 16 graphene layers, no more than about 15 graphene layers, no more than about 14 graphene layers, no more than about 13 graphene layers, no more than about 12 graphene layers, no more than about 11 graphene layers, no more than about 10 graphene layers, no more than about 9 graphene layers, no more than about 8 graphene layers, no more than about 7 graphene layers, no more than about 6 graphene layers, no more than about 5 graphene layers, no more than about 4 graphene layers, no more than about 3 graphene layers, or no more than about 2 graphene layers. Combinations of the above-referenced thicknesses of the graphene flakes 120 are also possible (e.g., at least about 1 graphene layer and no more than about 20 graphene layers or at least about 5 graphene layers and no more than about 10 graphene layers), inclusive of all values and ranges therebetween. In some embodiments, the graphene flakes 120 can have a thickness of about 1 graphene layer, about 2 graphene layers, about 3 graphene layers, about 4 graphene layers, about 5 graphene layers, about 6 graphene layers, about 7 graphene layers, about 8 graphene layers, about 9 graphene layers, about 10 graphene layers, about 11 graphene layers, about 12 graphene layers, about 13 graphene layers, about 14 graphene layers, about 15 graphene layers, about 16 graphene layers, about 17 graphene layers, about 18 graphene layers, about 19 graphene layers, or about 20 graphene layers.

In some embodiments, the graphene flakes 120 can have an aspect ratio of at least about 50, at least about 100, at least about 500, at least about 1,000, at least about 5,000, at least about 10,000, at least about 20,000, at least about 30,000, or at least about 40,000. In some embodiments, the graphene flakes 120 can have an aspect ratio of no more than about 50,000, no more than about 40,000, no more than about 30,000, no more than about 20,000, no more than about 10,000, no more than about 5,000, no more than about 1,000, no more than about 500, or no more than about 100. Combinations of the above-referenced aspect ratios are also possible (e.g., at least about 50 and no more than about 50,000 or at least about 500 and no more than about 5,000), inclusive of all values and ranges therebetween. In some embodiments, the graphene flakes 120 can have an aspect ratio of about 50, about 100, about 500, about 1,000, about 5,000, about 10,000, about 20,000, about 30,000, about 40,000, or about 50,000.

In some embodiments, the graphene flakes 120 can be agglomerated together in groups of about 2 flakes, about 3 flakes, about 4 flakes, about 5 flakes, about 6 flakes, about 7 flakes, about 8 flakes, about 9 flakes, about 10 flakes, about 20 flakes, about 30 flakes, about 40 flakes, about 50 flakes, about 60 flakes, about 70 flakes, about 80 flakes, about 90 flakes, about 100 flakes, about 200 flakes, about 300 flakes, about 400 flakes, or about 500 flakes, inclusive of all values and ranges therebetween.

In some embodiments, the reinforcement material 130 can include fiber reinforcement. The fiber reinforcement includes a collection of fibers dispersed in the thermoset matrix 110. The fiber reinforcement can act as a kneading element to de-agglomerate the graphene flakes 120. In some embodiments, the fiber reinforcement can have a concentration in the SMC 100 of at least about 10 wt%, at least about 15 wt%, at least about 20 wt%, at least about 25 wt%, at least about 30 wt%, at least about 35 wt%, at least about 40 wt%, or at least about 45 wt%. In some embodiments, the fiber reinforcement can have a concentration in the SMC 100 of no more than about 50 wt%, no more than about 45 wt%, no more than about 40 wt%, no more than about 35 wt%, no more than about 30 wt%, no more than about 25 wt%, no more than about 20 wt%, or no more than about 15 wt%. Combinations of the above-referenced concentrations of the fiber reinforcement in the SMC 100 are also possible (e.g., at least about 10 wt% and no more than about 50 wt% or at least about 20 wt% and no more than about 40 wt%), inclusive of all values and ranges therebetween. In some embodiments, the fiber reinforcement can have a concentration in the SMC 100 of about 10 wt%, about 15 wt%, about 20 wt%, about 25 wt%, about 30 wt%, about 35 wt%, about 40 wt%, about 45 wt%, or about 50 wt%.

In some embodiments, the fiber reinforcement can include fibers with lengths of at least about 1 mm, at least about 2 mm, at least about 3 mm, at least about 4 mm, at least about 5 mm, at least about 10 mm, at least about 15 mm, at least about 20 mm, at least about 25 mm, at least about 30 mm, at least about 35 mm, at least about 40 mm, or at least about 45 mm. In some embodiments, the fiber reinforcement can include fibers with lengths of no more than about 50 mm, no more than about 45 mm, no more than about 40 mm, no more than about 35 mm, no more than about 30 mm, no more than about 25 mm, no more than about 20 mm, no more than about 15 mm, no more than about 10 mm, no more than about 5 mm, no more than about 4 mm, no more than about 3 mm, or no more than about 2 mm. Combinations of the above-referenced lengths of the fibers in the fiber reinforcement are also possible (e.g., at least about 1 mm and no more than about 50 mm or at least about 5 mm and no more than about 30 mm), inclusive of all values and ranges therebetween. In some embodiments, the fiber reinforcement can include fibers with lengths of about 1 mm, about 2 mm, about 3 mm, about 4 mm, about 5 mm, about 10 mm, about 15 mm, about 20 mm, about 25 mm, about 30 mm, about 35 mm, about 40 mm, about 45 mm, or about 50 mm.

In some embodiments, the reinforcement material 130 can include glass fiber, carbon fiber, metallic fibers, polymer fibers, polyester fibers, Kevlar, nylon, or any combination thereof. In some embodiments, the reinforcement material 130 can include beads. In some embodiments, the reinforcement material 130 can include glass beads (also known as “glass microspheres”). In some embodiments, the reinforcement material 130 can include glass hollow bubbles. In some embodiments, the glass beads can comprise borosilicate.

In some embodiments, the glass beads can have a density of at least about 0.15 g/ml, at least about 0.2 g/ml, at least about 0.25 g/ml, at least about 0.3 g/ml, at least about 0.35 g/ml, at least about 0.4 g/ml, at least about 0.45 g/ml, at least about 0.5 g/ml, or at least about 0.55 g/ml. In some embodiments, the glass beads can have a density of no more than about 0.6 g/ml, no more than about 0.55 g/ml, no more than about 0.5 g/ml, no more than about 0.45 g/ml, no more than about 0.4 g/ml, no more than about 0.35 g/ml, no more than about 0.3 g/ml, no more than about 0.25 g/ml, or no more than about 0.2 g/ml. Combinations of the above-referenced densities of the glass beads are also possible (e.g., at least about 0.15 g/ml and no more than about 0.6 g/ml or at least about 0.25 g/ml and no more than about 0.5 g/ml), inclusive of all values and ranges therebetween. In some embodiments, the glass beads can have a density of about 0.15 g/ml, about 0.2 g/ml, about 0.25 g/ml, about 0.3 g/ml, about 0.35 g/ml, about 0.4 g/ml, about 0.45 g/ml, about 0.5 g/ml, about 0.55 g/ml, or about 0.6 g/ml.

In some embodiments, the glass beads can have a spherical or substantially spherical shape. In some embodiments, the glass beads can have a diameter of at least about 2 µm, at least about 3 µm, at least about 4 µm, at least about 5 µm, at least about 6 µm, at least about 7 µm, at least about 8 µm, at least about 9 µm, at least about 10 µm, at least about 15 µm, at least about 20 µm, at least about 25 µm, at least about 30 µm, at least about 35 µm, at least about 40 µm, at least about 45 µm, at least about 50 µm, at least about 55 µm, at least about 60 µm, at least about 65 µm, at least about 70 µm, at least about 75 µm, at least about 80 µm, at least about 85 µm, at least about 90 µm, at least about 95 µm, at least about 100 µm, at least about 105 µm, at least about 110 µm, at least about 115 µm, or at least about 120 µm. In some embodiments, the glass beads can have a diameter of no more than about 125 µm, no more than about 120 µm, no more than about 115 µm, no more than about 110 µm, no more than about 105 µm, no more than about 100 µm, no more than about 95 µm, no more than about 90 µm, no more than about 85 µm, no more than about 80 µm, no more than about 75 µm, no more than about 70 µm, no more than about 65 µm, no more than about 60 µm, no more than about 55 µm, no more than about 50 µm, no more than about 45 µm, no more than about 40 µm, no more than about 35 µm, no more than about 30 µm, no more than about 25 µm, no more than about 20 µm, no more than about 15 µm, no more than about 10 µm, no more than about 9 µm, no more than about 8 µm, no more than about 7 µm, no more than about 6 µm, no more than about 5 µm, no more than about 4 µm, or no more than about 3 µm.

Combinations of the above-referenced diameters are also possible (e.g., at least about 2 µm and no more than about 125 µm or at least about 10 µm and no more than about 60 µm), inclusive of all values and ranges therebetween. In some embodiments, the glass beads can have a diameter of about 2 µm, about 3 µm, about 4 µm, about 5 µm, about 6 µm, about 7 µm, about 8 µm, about 9 µm, about 10 µm, about 15 µm, about 20 µm, about 25 µm, about 30 µm, about 35 µm, about 40 µm, about 45 µm, about 50 µm, about 55 µm, about 60 µm, about 65 µm, about 70 µm, about 75 µm, about 80 µm, about 85 µm, about 90 µm, about 95 µm, about 100 µm, about 105 µm, about 110 µm, about 115 µm, about 120 µm, or about 125 µm.

In some embodiments, the glass beads can be hollow. In some embodiments, the glass beads can have a wall thickness of at least about 1 µm, at least about 1.1 µm, at least about 1.2 µm, at least about 1.3 µm, at least about 1.4 µm, at least about 1.5 µm, at least about 1.6 µm, at least about 1.7 µm, at least about 1.8 µm, at least about 1.9 µm. In some embodiments, the glass beads can have a wall thickness of no more than about 2 µm, no more than about 1.8 µm, no more than about 1.7 µm, no more than about 1.6 µm, no more than about 1.5 µm, no more than about 1.4 µm, no more than about 1.3 µm, no more than about 1.2 µm, no more than about 1.1 µm. Combinations of the above-referenced wall thicknesses are also possible (e.g., at least about 1 µm and no more than about 2 µm or at least about 1.2 µm and no more than about 1.8 µm), inclusive of all values and ranges therebetween. In some embodiments, the glass beads can have a wall thickness of about 1 µm, about 1.1 µm, about 1.2 µm, about 1.3 µm, about 1.4 µm, about 1.5 µm, about 1.6 µm, about 1.7 µm, about 1.8 µm, about 1.9 µm, or about 2 µm.

In some embodiments, the glass beads can be incorporated into the thermoset matrix 110 without the mineral filler, in order to keep the density of the SMC 100 as low as possible. In some embodiments, the glass beads can make up at least about 25 wt%, at least about 26 wt%, at least about 27 wt%, at least about 28 wt%, at least about 29 wt%, at least about 30 wt%, at least about 31 wt%, at least about 32 wt%, at least about 33 wt%, at least about 34 wt%, at least about 35 wt%, at least about 36 wt%, at least about 37 wt%, at least about 38 wt%, or at least about 39 wt% of the thermoset matrix 110. In some embodiments, the glass beads can make up no more than about 40 wt%, no more than about 39 wt%, no more than about 38 wt%, no more than about 37 wt%, no more than about 36 wt%, no more than about 35 wt%, no more than about 34 wt%, no more than about 33 wt%, no more than about 32 wt%, no more than about 31 wt%, no more than about 30 wt%, no more than about 29 wt%, no more than about 28 wt%, no more than about 27 wt%, or no more than about 26 wt% of the thermoset matrix 110. Combinations of the above-referenced weight percentages of the glass beads are also possible (e.g., at least about 25 wt% and no more than about 40 wt% or at least about 30 wt% and no more than about 35 wt%), inclusive of all values and ranges therebetween. In some embodiments, the glass beads can make up about 25 wt%, about 26 wt%, about 27 wt%, about 28 wt%, about 29 wt%, about 30 wt%, about 31 wt%, about 32 wt%, about 33 wt%, about 34 wt%, about 35 wt%, about 36 wt%, about 37 wt%, about 38 wt%, about 39 wt%, or about 40 wt% of the thermoset matrix 110.

In some embodiments, the mineral filler 140 can include a powder. In some embodiments, the mineral filler 140 can be integrated into the thermoset matrix 110. In some embodiments, the mineral filler 140 can be added to the reinforcement material 130. In some embodiments, inclusion of the mineral filler 140 and the reinforcement material 130 in the SMC 100 can reduce the cost and shrinkage of the SMC 100 during production. In some embodiments, the mineral filler 140 can include CaCO₃.

In some embodiments, the mineral filler 140 can include particles with particle sizes of at least about 2 µm, at least about 3 µm, at least about 4 µm, at least about 5 µm, at least about 6 µm, at least about 7 µm, at least about 8 µm, at least about 9 µm, at least about 10 µm, at least about 11 µm, at least about 12 µm, at least about 13 µm, or at least about 14 µm. In some embodiments, the mineral filler 140 can include particles with particle sizes of no more than about 15 µm, no more than about 14 µm, no more than about 13 µm, no more than about 12 µm, no more than about 11 µm, no more than about 10 µm, no more than about 9 µm, no more than about 8 µm, no more than about 7 µm, no more than about 6 µm, no more than about 5 µm, no more than about 4 µm, or no more than about 3 µm. Combinations of the above-referenced particle sizes are also possible (e.g., at least about 2 µm and no more than about 15 µm or at least about 5 µm and no more than about 10 µm), inclusive of all values and ranges therebetween. In some embodiments, the mineral filler 140 can include particles with particle sizes of about 2 µm, about 3 µm, about 4 µm, about 5 µm, about 6 µm, about 7 µm, about 8 µm, about 9 µm, about 10 µm, about 11 µm, about 12 µm, about 13 µm, about 14 µm, or about 15 µm.

In some embodiments, the thermoset matrix 110 can include at least about 25 wt%, at least about 30 wt%, at least about 35 wt%, at least about 40 wt%, at least about 45 wt%, at least about 50 wt%, or at least about 55 wt% mineral filler 140. In some embodiments, the thermoset matrix 110 can include no more than about 60 wt%, no more than about 55 wt%, no more than about 50 wt%, no more than about 45 wt%, no more than about 40 wt%, no more than about 35 wt%, or no more than about 30 wt% mineral filler. Combinations of the above-referenced weight percentages of the mineral filler 140 in the thermoset matrix 110 are also possible (e.g., at least about 25 wt% and no more than about 60 wt% or at least about 40 wt% and no more than about 50 wt%), inclusive of all values and ranges therebetween. In some embodiments, the thermoset matrix 110 can include about 25 wt%, about 30 wt%, about 35 wt%, about 40 wt%, about 45 wt%, about 50 wt%, about 55 wt%, or about 60 wt% mineral filler 140.

In some embodiments, the mold release agent 150 can be included in the SMC 100. In some embodiments, the mold release agent 150 can be included in the thermoset matrix 110. In some embodiments, the mold release agent 150 can include a fatty acid salt such as a stearate of a metal ion. In some embodiments, the mold release agent 150 can include aluminum stearate, calcium stearate, magnesium stearate, and/or zinc stearate.

In some embodiments, the thermoset matrix 110 can include at least about 0.5 wt%, at least about 0.6 wt%, at least about 0.7 wt%, at least about 0.8 wt%, at least about 0.9 wt%, at least about 1.0 wt%, at least about 1.1 wt%, at least about 1.2 wt%, at least about 1.3 wt%, at least about 1.4 wt%, at least about 1.5 wt%, at least about 1.6 wt%, at least about 1.7 wt%, at least about 1.8 wt%, at least about 1.9 wt%, at least about 2.0 wt%, at least about 2.1 wt%, at least about 2.2 wt%, at least about 2.3 wt%, or at least about 2.4 wt% of the mold release agent 150. In some embodiments, the thermoset matrix 110 can include no more than about 2.5 wt%, no more than about 2.4 wt%, no more than about 2.3 wt%, no more than about 2.2 wt%, no more than about 2.1 wt%, no more than about 2.0 wt%, no more than about 1.9 wt%, no more than about 1.8 wt%, no more than about 1.7 wt%, no more than about 1.6 wt%, no more than about 1.5 wt%, no more than about 1.4 wt%, no more than about 1.3 wt%, no more than about 1.2 wt%, no more than about 1.1 wt%, no more than about 1.0 wt%, no more than about 0.9 wt%, no more than about 0.8 wt%, no more than about 0.7 wt%, or no more than about 0.6 wt%. Combinations of the above-referenced weight percentages are also possible (e.g., at least about 0.5 wt% and no more than about 2.5 wt% or at least about 1 wt% and no more than about 2 wt%), inclusive of all values and ranges therebetween. In some embodiments, the thermoset matrix 110 can include about 0.5 wt%, about 0.6 wt%, about 0.7 wt%, about 0.8 wt%, about 0.9 wt%, about 1.0 wt%, about 1.1 wt%, about 1.2 wt%, about 1.3 wt%, about 1.4 wt%, about 1.5 wt%, about 1.6 wt%, about 1.7 wt%, about 1.8 wt%, about 1.9 wt%, about 2.0 wt%, about 2.1 wt%, about 2.2 wt%, about 2.3 wt%, about 2.4 wt%, or about 2.5 wt% of the mold release agent 150.

In some embodiments, the SMC 100 can include one or more low profile additives (LPA) 160. In some embodiments, the LPA 160 can include thermoplastics incorporated into an unsaturated polyester resin in order to improve a surface finish of the SMC 100.

In some embodiments, the SMC 100 can be formed into a slab of material. In some embodiments, the SMC 100 can be formed into a shape of an article. In some embodiments, the slab of material can be substantially planar. In some embodiments, the article can include an automobile hatch, an electrical housing, a sewing machine, dinnerware, and/or electrical components.

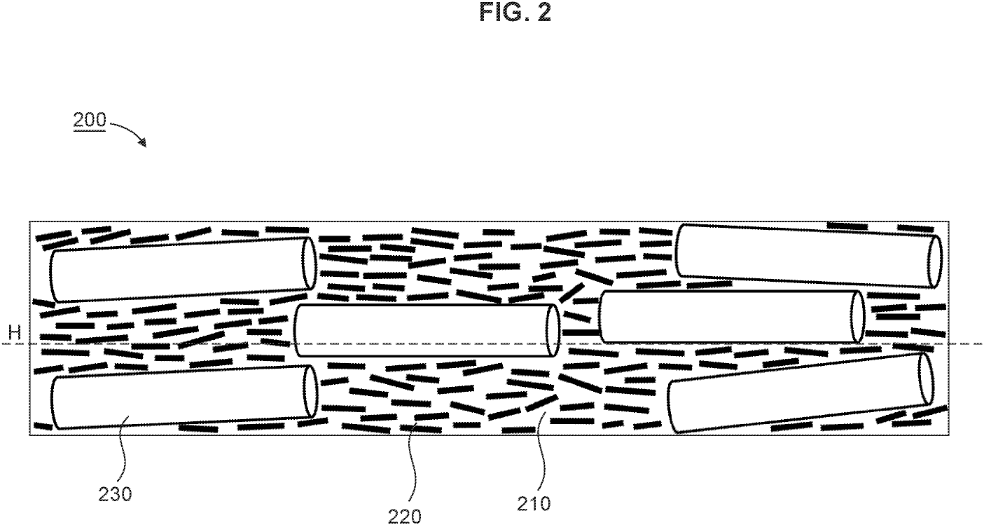

FIG. 2 is an illustration of an SMC 200, according to an embodiment. As shown, the SMC 200 includes a thermoset matrix 210 with graphene flakes 220 and fiber reinforcement 230 dispersed therein. In some embodiments, the thermoset matrix 210, the graphene flakes 220, and the fiber reinforcement 230 can be the same or substantially similar to the thermoset matrix 110, the graphene flakes 120, and the reinforcement material 130, as described above with reference to FIG. 1. Thus, certain aspects of the thermoset matrix 210, the graphene flakes 220, and the fiber reinforcement 230 are not described in greater detail herein. In some embodiments, the SMC 200 can include a mineral filler (not shown) and/or a mold release agent (not shown), the same or substantially similar to the mineral filler 140 and the mold release agent 150 described above with reference to FIG. 1.

As shown in FIG. 2, a horizontal plane H represents the flow direction of the SMC 200 during formation of the SMC 200. In other words, while in a flowable form (i.e., while the SMC 200 is being pressed), the SMC 200 flows along the horizontal plane H. Once pressed, the SMC 200 can be formed into a slab and/or an article with a thickness (i.e., a dimension perpendicular to the horizontal plane H) of at least about 100 µm, at least about 200 µm, at least about 300 µm, at least about 400 µm, at least about 500 µm, at least about 600 µm, at least about 700 µm, at least about 800 µm, at least about 900 µm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the SMC 200 can be formed into a slab and/or an article with a thickness of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 µm, no more than about 800 µm, no more than about 700 µm, no more than about 600 µm, no more than about 500 µm, no more than about 400 µm, no more than about 300 µm, or no more than about 200 µm.

Combinations of the above-referenced thickness values of the slab and/or article formed from the SMC 200 are also possible (e.g., at least about 100 µm and no more than about 10 cm, or at least about 1 mm and no more than about 5 mm), inclusive of all values and ranges therebetween. In some embodiments, the slab and/or article formed from the SMC can have a thickness of about 100 µm, about 200 µm, about 300 µm, about 400 µm, about 500 µm, about 600 µm, about 700 µm, about 800 µm, about 900 µm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

As shown, a substantial number of the graphene flakes 220 have a lateral dimension that is parallel or substantially parallel to the horizontal plane H. In some embodiments, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, or at least about 99.9% of the graphene flakes 220 can have a lateral dimension that is within a threshold angle of aligning parallel to the horizontal plane H, inclusive of all values and ranges therebetween. In some embodiments, the threshold angle can be about 1 degree, about 2 degrees, about 3 degrees, about 4 degrees, about 5 degrees, about 6 degrees, about 7 degrees, about 8 degrees, about 9 degrees, about 10 degrees, about 11 degrees, about 12 degrees, about 13 degrees, about 14 degrees, about 15 degrees, about 16 degrees, about 17 degrees, about 18 degrees, about 19 degrees, or about 20 degrees, inclusive of all values and ranges therebetween.

As shown, a substantial number of the fiber reinforcements 230 are parallel or substantially parallel to the horizontal plane H. In some embodiments, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, or at least about 99.9% of the fiber reinforcements 230 can have a lateral dimension that is within a threshold angle of aligning parallel to the horizontal plane H, inclusive of all values and ranges therebetween. In some embodiments, the threshold angle can be about 1 degree, about 2 degrees, about 3 degrees, about 4 degrees, about 5 degrees, about 6 degrees, about 7 degrees, about 8 degrees, about 9 degrees, about 10 degrees, about 11 degrees, about 12 degrees, about 13 degrees, about 14 degrees, about 15 degrees, about 16 degrees, about 17 degrees, about 18 degrees, about 19 degrees, or about 20 degrees, inclusive of all values and ranges therebetween

In some embodiments, the SMC 200 and/or an article formed therefrom can have a Young’s modulus of at least about 10 GPa, at least about 10.5 GPa, at least about 11 GPa, at least about 12 GPa, at least about 12.5 GPa, at least about 13 GPa, at least about 13.5 GPa, at least about 14 GPa, at least about 14.5 GPa, at least about 15 GPa.

In some embodiments, the SMC 200 and/or an article formed therefrom can have a flexural modulus of at least about 6 GPa, at least about 6.5 GPa, at least about 7 GPa, at least about 7.5 GPa, at least about 8 GPa, at least about 8.5 GPa, at least about 9 GPa, at least about 9.5 GPa, at least about 10 GPa, at least about 10.5 GPa, at least about 11 GPa, at least about 12 GPa, at least about 12.5 GPa, at least about 13 GPa, at least about 13.5 GPa, at least about 14 GPa, at least about 14.5 GPa, at least about 15 GPa.

In some embodiments, the SMC 200 and/or an article formed therefrom can have an elongation at break of at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2.0%, at least about 2.1%, at least about 2.2%, at least about 2.3%, at least about 2.4%, at least about 2.5%, at least about 2.6%, at least about 2.7%, at least about 2.8%, at least about 2.9%, at least about 3.0%, at least about 3.1%, at least about 3.2%, at least about 3.3%, at least about 3.4%, at least about 3.5%, at least about 3.6%, at least about 3.7%, at least about 3.8%, at least about 3.9%, at least about 4.0%, at least about 4.1%, at least about 4.2%, at least about 4.3%, at least about 4.4%, at least about 4.5%, at least about 4.6%, at least about 4.7%, at least about 4.8%, at least about 4.9%, or at least about 5.0%.

In some embodiments, the SMC 200 and/or an article formed therefrom can have a flexural strength of at least about 100 MPa, at least about 110 MPa, at least about 120 MPa, at least about 130 MPa, at least about 140 MPa, at least about 150 MPa, at least about 160 MPa, at least about 170 MPa, at least about 180 MPa, at least about 190 MPa, or at least about 200 MPa.

In some embodiments, the SMC 200 and/or an article formed therefrom can have a tensile strength of at least about 50 MPa, at least about 55 MPa, at least about 60 MPa, at least about 64 MPa, at least about 65 MPa, at least about 70 MPa, at least about 75 MPa, at least about 80 MPa, at least about 85 MPa, at least about 90 MPa, at least about 95 MPa, at least about 100 MPa, at least about 105 MPa, at least about 110 MPa, at least about 115 MPa, or at least about 120 MPa.

In some embodiments, the SMC 200 and/or an article formed therefrom can have an impact resistance of at least about 800 J/m, at least about 810 J/m, at least about 820 J/m, at least about 830 J/m, at least about 840 J/m, at least about 850 J/m, at least about 860 J/m, at least about 870 J/m, at least about 880 J/m, at least about 890 J/m, at least about 900 J/m, at least about 910 J/m, at least about 920 J/m, at least about 930 J/m, at least about 940 J/m, at least about 950 J/m, at least about 960 J/m, at least about 970 J/m, at least about 980 J/m, at least about 990 J/m, or at least about 1,000 J/m.

An additional benefit of the parallel or near parallel alignment of the graphene flakes 220 is moisture resistance. In some embodiments, moisture resistance of the SMC 200 can improve by at least about 5%, at least about 10%, at least about 15%, at least about 20%, at least about 25%, at least about 30%, at least about 35%, or about 40%, when compared to an SMC article without graphene. The improvement in moisture resistance can aid in avoiding blistering in humid conditions, improve paint quality, reduce surface waviness, and/or increase crack resistance.

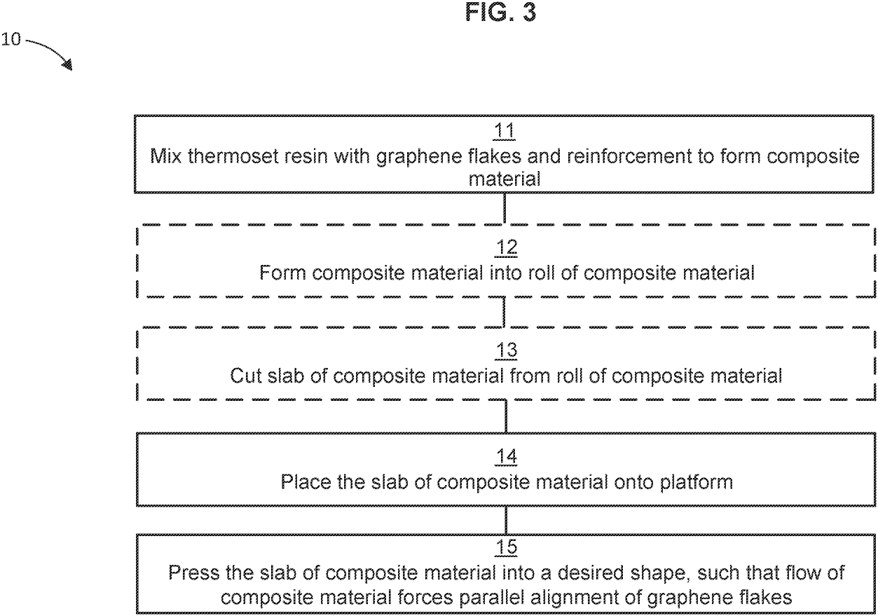

FIG. 3 shows a block diagram of a method 10 of producing SMC, according to an embodiment. As shown, the method 10 includes mixing a thermoset resin graphene flakes and reinforcement material to form a composite material at step 11. The method 10 optionally includes forming the composite material into a roll of composite material at step 12 and cutting a slab of composite material from a roll of the composite material at step 13. The method 10 further includes placing the slab of composite material onto a platform at step 14 and pressing the slab of composite material into a desired shape, such that flow of composite material forces parallel alignment of graphene flakes at step 15.

Step 11 includes mixing the thermoset resin graphene flakes and reinforcement material to form the composite material. The reinforcement material includes at least one of a plurality of fibers (i.e., reinforcement fibers) or a plurality of beads. In some embodiments, the graphene flakes can be mixed into the thermoset resin prior to the reinforcement fibers or any other additives. In some embodiments, the graphene flakes can be mixed into the thermoset resin via shear mixing. In some embodiments, the mixing can include dispensing a resin onto a carrier film. In some embodiments, the graphene flakes can be mixed into the resin prior to dispensing the resin onto the carrier film. In some embodiments, the graphene flakes can be mixed into the resin after the dispensing of the resin onto the carrier film. In some embodiments, the reinforcement fibers can be distributed onto a surface of the carrier film via a chopper that cuts the reinforcement fibers and conveys or drops them onto the carrier film surface. After the reinforcement fibers and/or the beads are distributed on the carrier film surface, an additional layer of thermoset resin can be added to the surface of the carrier film, such that the reinforcement fibers have thermoset resin on either side. In some embodiments, step 11 can include mixing a mineral filler into the thermoset resin. In some embodiments, step 11 can include mixing a mold release agent into the thermoset resin.

Step 12 is optional and includes forming the composite material into a roll of composite material. The roll of composite material can be rolled onto a spool. In some embodiments, the roll of composite material can have a barrier on either side of the composite material (e.g., a plastic film) to keep the composite material layers from mixing together or becoming stuck together. In some embodiments, one spool of composite material can have a mass of at least about 100 kg, at least about 200 kg, at least about 300 kg, at least about 400 kg, at least about 500 kg, at least about 600 kg, at least about 700 kg, at least about 800 kg, at least about 900 kg, at least about 1,000 kg, at least about 1,500 kg, at least about 2,000 kg, at least about 2,500 kg, at least about 3,000 kg, at least about 3,500 kg, at least about 4,000 kg, at least about 4,500 kg, or at least about 5,000 kg, inclusive of all values and ranges therebetween.

Step 13 is optional and includes cutting a slab of composite material from the roll of composite material. The amount of composite material cut from the roll of composite material can be fine-tuned to the amount desired for a specific application. In some embodiments, step 13 can include cutting multiple slabs and stacking them together.

Step 14 includes placing the slab or slabs of composite material onto a platform. In some embodiments, step 14 includes stacking multiple slabs together. In some embodiments, stacking and placement of sheets of composite material can be fine-tuned for a desired flow of material.

Step 15 includes pressing a slab of composite material into a desired shape, such that a flow of composite material forces parallel or substantially parallel alignment of the graphene flakes. The flow direction of resin influences alignment of graphene flakes. In other words, as the thermoset resin is flowing, the graphene flakes align themselves in the most energetically favorable way possible. This would include aligning parallel or substantially parallel to the flow of the resin, as aligning perpendicular to the flow of the resin would create energetically unfavorable flow impedance.

In some embodiments, the pressing at step 15 can impose a pressing force of at least about 5,000 kN, at least about 10,000 kN, at least about 15,000 kN, at least about 20,000 kN, at least about 25,000 kN, at least about 30,000 kN, at least about 35,000 kN, at least about 40,000 kN, or at least about 45,000 kN. In some embodiments, the pressing at step 15 can impose a pressing force of no more than about 50,000 kN, no more than about 45,000 kN, no more than about 40,000 kN, no more than about 35,000 kN, no more than about 30,000 kN, no more than about 25,000 kN, no more than about 20,000 kN, no more than about 15,000 kN, or no more than about 10,000 kN. Combinations of the above-referenced pressing forces are also possible (e.g., at least about 5,000 kN and no more than about 50,000 kN or at least about 10,000 kN and no more than about 40,000 kN), inclusive of all values and ranges therebetween. In some embodiments, the pressing at step 15 can impose a pressing force of about 5,000 kN, about 10,000 kN, about 15,000 kN, about 20,000 kN, about 25,000 kN, about 30,000 kN, about 35,000 kN, about 40,000 kN, about 45,000 kN, or about 50,000 kN.

In some embodiments, the pressing at step 15 can impose a pressing speed (while pressing the SMC material) of at least about 1 mm/s, at least about 2 mm/s, at least about 3 mm/s, at least about 4 mm/s, at least about 5 mm/s, at least about 6 mm/s, at least about 7 mm/s, at least about 8 mm/s, at least about 9 mm/s, at least about 1 cm/s, at least about 2 cm/s, at least about 1 cm/s, at least about 2 cm/s, at least about 3 cm/s, at least about 4 cm/s, at least about 5 cm/s, at least about 6 cm/s, at least about 7 cm/s, at least about 8 cm/s, or at least about 9 cm/s. In some embodiments, the pressing at step 15 can impose a pressing speed of no more than about 10 cm/s, no more than about 9 cm/s, no more than about 8 cm/s, no more than about 7 cm/s, no more than about 6 cm/s, no more than about 5 cm/s, no more than about 4 cm/s, no more than about 3 cm/s, no more than about 2 cm/s, no more than about 1 cm/s, no more than about 9 mm/s, no more than about 8 mm/s, no more than about 7 mm/s, no more than about 6 mm/s, no more than about 5 mm/s, no more than about 4 mm/s, no more than about 3 mm/s, or no more than about 2 mm/s. Combinations of the above-referenced pressing speeds are also possible (e.g., at least about 1 mm/s and no more than about 10 cm/s or at least about 2 mm/s and no more than about 8 mm/s), inclusive of all values and ranges therebetween. In some embodiments, the pressing at step 15 can impose a pressing speed (while pressing the SMC material) of about 1 mm/s, about 2 mm/s, about 3 mm/s, about 4 mm/s, about 5 mm/s, about 6 mm/s, about 7 mm/s, about 8 mm/s, about 9 mm/s, about 1 cm/s, about 2 cm/s, about 1 cm/s, about 2 cm/s, about 3 cm/s, about 4 cm/s, about 5 cm/s, about 6 cm/s, about 7 cm/s, about 8 cm/s, about 9 cm/s, or about 10 cm/s.

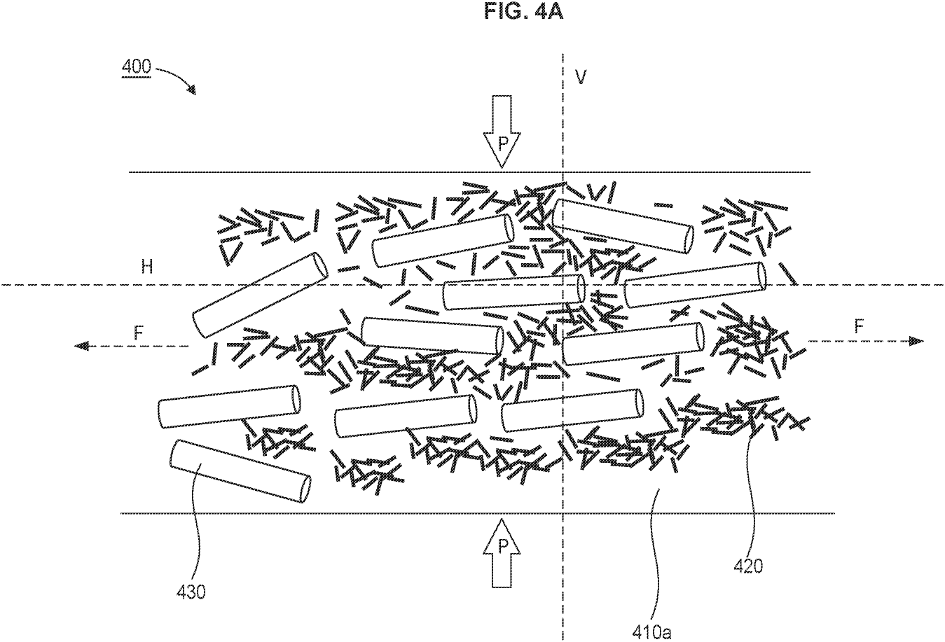

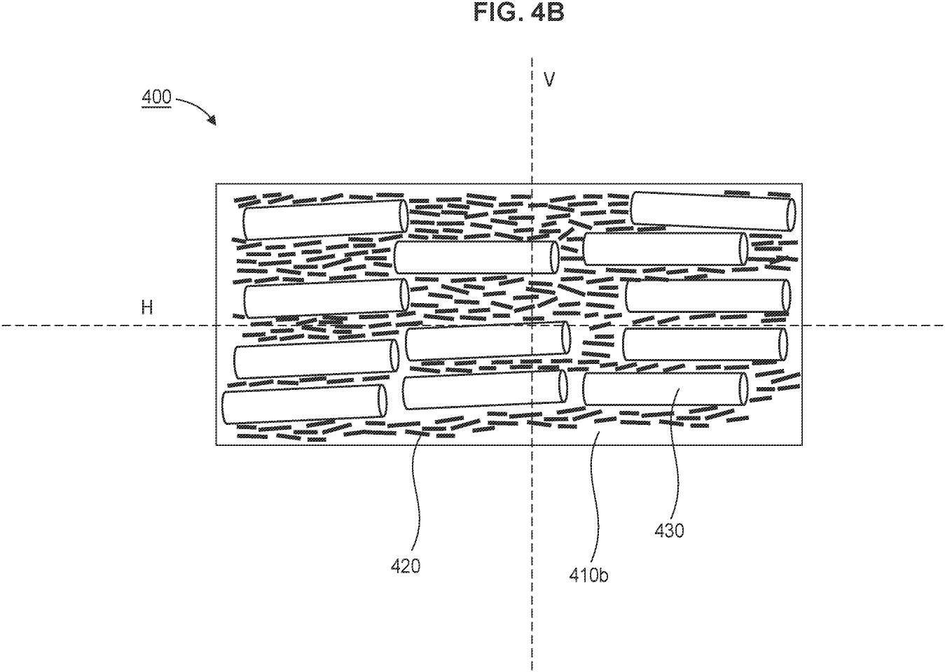

FIGS. 4A-4B illustrate a process of pressing SMC 400, according to an embodiment. FIG. 4A shows the SMC 400 with the various components dispersed therein during the pressing process, while FIG. 4B shows the SMC 400 after being pressed. As shown, the SMC 400 includes a flowing thermoset resin 410a in FIG. 4A and a thermoset matrix 410b in FIG. 4B. The SMC 400 further includes graphene flakes 420 and fiber reinforcement 430. In some embodiments, the thermoset matrix 410b, the graphene flakes 420, and the fiber reinforcement 430 can be the same or substantially similar to the thermoset matrix 210, the graphene flakes 220, and the fiber reinforcement 230, as described above with reference to FIG. 2. Thus, certain aspects of the thermoset matrix 410b, the graphene flakes 420, and the fiber reinforcement 430 are not described in greater detail herein.

FIGS. 4A and 4B show a horizontal plane H and a vertical plane V for reference. As shown in FIG. 4A, a pressing force P is imposed on the SMC 400 in a direction perpendicular or substantially perpendicular to the horizontal plane. The pressing force P induces flow of the thermoset resin 410a (and the components dispersed therein) away from a vertical plane V. The thermoset resin 410a flows along the flow lines F. Upon flow of the thermoset resin 410a, the graphene flakes 420 align parallel or substantially parallel with the horizontal plane H, due to the thermodynamic favorability of such an alignment. In other words, the graphene flakes 420 orient themselves to block the flow of the thermoset resin 410a as little as possible. Upon flow of the thermoset resin 410a, the fibers of the fiber reinforcement 430 can also align parallel or substantially parallel with the horizontal plane H. The SMC 400 that results from such flow is depicted in FIG. 4B, which shows a significant percentage of the graphene flakes 420 and a significant percentage of the fibers of the fiber reinforcement 430 aligned parallel or substantially parallel to the horizontal plane H.

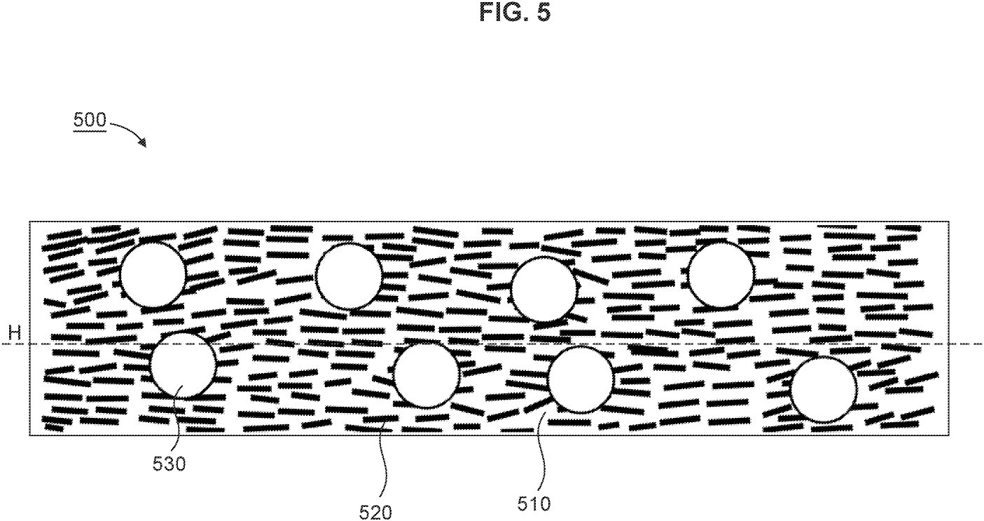

FIG. 5 is an illustration of an SMC 500, according to an embodiment. As shown, the SMC 500 includes a thermoset matrix 510 with graphene flakes 520 and reinforcement beads 530 dispersed therein. In some embodiments, the thermoset matrix 510, the graphene flakes 520, and the reinforcement beads 530 can be the same or substantially similar to the thermoset matrix 110, the graphene flakes 120, and the reinforcement material 130, as described above with reference to FIG. 1. Thus, certain aspects of the thermoset matrix 510, the graphene flakes 520, and the reinforcement beads 530 are not described in greater detail herein. In some embodiments, the SMC 500 can include a mineral filler (not shown) and/or a mold release agent (not shown), the same or substantially similar to the mineral filler 140 and the mold release agent 150 described above with reference to FIG. 1. As shown in FIG. 5, a horizontal plane H represents the flow direction of the SMC 500 during formation of the SMC 500. In other words, while in a flowable form (i.e., while the SMC 500 is being pressed), the SMC 500 flows along the horizontal plane H. Once pressed, the SMC 500 can be formed into a slab and/or an article

In some embodiments, the reinforcement beads 530 can include glass beads. In some embodiments, the reinforcement beads 530 can include borosilicate beads. In some embodiments, the reinforcement beads 530 can have a density of at least about 0.15 g/ml, at least about 0.2 g/ml, at least about 0.25 g/ml, at least about 0.3 g/ml, at least about 0.35 g/ml, at least about 0.4 g/ml, at least about 0.45 g/ml, at least about 0.5 g/ml, or at least about 0.55 g/ml. In some embodiments, the reinforcement beads 530 can have a density of no more than about 0.6 g/ml, no more than about 0.55 g/ml, no more than about 0.5 g/ml, no more than about 0.45 g/ml, no more than about 0.4 g/ml, no more than about 0.35 g/ml, no more than about 0.3 g/ml, no more than about 0.25 g/ml, or no more than about 0.2 g/ml. Combinations of the above-referenced densities of the reinforcement beads 530 are also possible (e.g., at least about 0.15 g/ml and no more than about 0.6 g/ml or at least about 0.25 g/ml and no more than about 0.5 g/ml), inclusive of all values and ranges therebetween. In some embodiments, the reinforcement beads 530 can have a density of about 0.15 g/ml, about 0.2 g/ml, about 0.25 g/ml, about 0.3 g/ml, about 0.35 g/ml, about 0.4 g/ml, about 0.45 g/ml, about 0.5 g/ml, about 0.55 g/ml, or about 0.6 g/ml.

In some embodiments, the reinforcement beads 530 can have a spherical or substantially spherical shape. In some embodiments, the reinforcement beads 530 can have a diameter of at least about 2 µm, at least about 3 µm, at least about 4 µm, at least about 5 µm, at least about 6 µm, at least about 7 µm, at least about 8 µm, at least about 9 µm, at least about 10 µm, at least about 15 µm, at least about 20 µm, at least about 25 µm, at least about 30 µm, at least about 35 µm, at least about 40 µm, at least about 45 µm, at least about 50 µm, at least about 55 µm, at least about 60 µm, at least about 65 µm, at least about 70 µm, at least about 75 µm, at least about 80 µm, at least about 85 µm, at least about 90 µm, at least about 95 µm, at least about 100 µm, at least about 105 µm, at least about 110 µm, at least about 115 µm, or at least about 120 µm. In some embodiments, the reinforcement beads 530 can have a diameter of no more than about 125 µm, no more than about 120 µm, no more than about 115 µm, no more than about 110 µm, no more than about 105 µm, no more than about 100 µm, no more than about 95 µm, no more than about 90 µm, no more than about 85 µm, no more than about 80 µm, no more than about 75 µm, no more than about 70 µm, no more than about 65 µm, no more than about 60 µm, no more than about 55 µm, no more than about 50 µm, no more than about 45 µm, no more than about 40 µm, no more than about 35 µm, no more than about 30 µm, no more than about 25 µm, no more than about 20 µm, no more than about 15 µm, no more than about 10 µm, no more than about 9 µm, no more than about 8 µm, no more than about 7 µm, no more than about 6 µm, no more than about 5 µm, no more than about 4 µm, or no more than about 3 µm.

Combinations of the above-referenced diameters are also possible (e.g., at least about 2 µm and no more than about 125 µm or at least about 10 µm and no more than about 60 µm), inclusive of all values and ranges therebetween. In some embodiments, the reinforcement beads 530 can have a diameter of about 2 µm, about 3 µm, about 4 µm, about 5 µm, about 6 µm, about 7 µm, about 8 µm, about 9 µm, about 10 µm, about 15 µm, about 20 µm, about 25 µm, about 30 µm, about 35 µm, about 40 µm, about 45 µm, about 50 µm, about 55 µm, about 60 µm, about 65 µm, about 70 µm, about 75 µm, about 80 µm, about 85 µm, about 90 µm, about 95 µm, about 100 µm, about 105 µm, about 110 µm, about 115 µm, about 120 µm, or about 125 µm.

In some embodiments, the reinforcement beads 530 can be hollow. In some embodiments, the reinforcement beads 530 can have a wall thickness of at least about 1 µm, at least about 1.1 µm, at least about 1.2 µm, at least about 1.3 µm, at least about 1.4 µm, at least about 1.5 µm, at least about 1.6 µm, at least about 1.7 µm, at least about 1.8 µm, at least about 1.9 µm. In some embodiments, the reinforcement beads 530 can have a wall thickness of no more than about 2 µm, no more than about 1.8 µm, no more than about 1.7 µm, no more than about 1.6 µm, no more than about 1.5 µm, no more than about 1.4 µm, no more than about 1.3 µm, no more than about 1.2 µm, no more than about 1.1 µm. Combinations of the above-referenced wall thicknesses are also possible (e.g., at least about 1 µm and no more than about 2 µm or at least about 1.2 µm and no more than about 1.8 µm), inclusive of all values and ranges therebetween. In some embodiments, the reinforcement beads 530 can have a wall thickness of about 1 µm, about 1.1 µm, about 1.2 µm, about 1.3 µm, about 1.4 µm, about 1.5 µm, about 1.6 µm, about 1.7 µm, about 1.8 µm, about 1.9 µm, or about 2 µm.

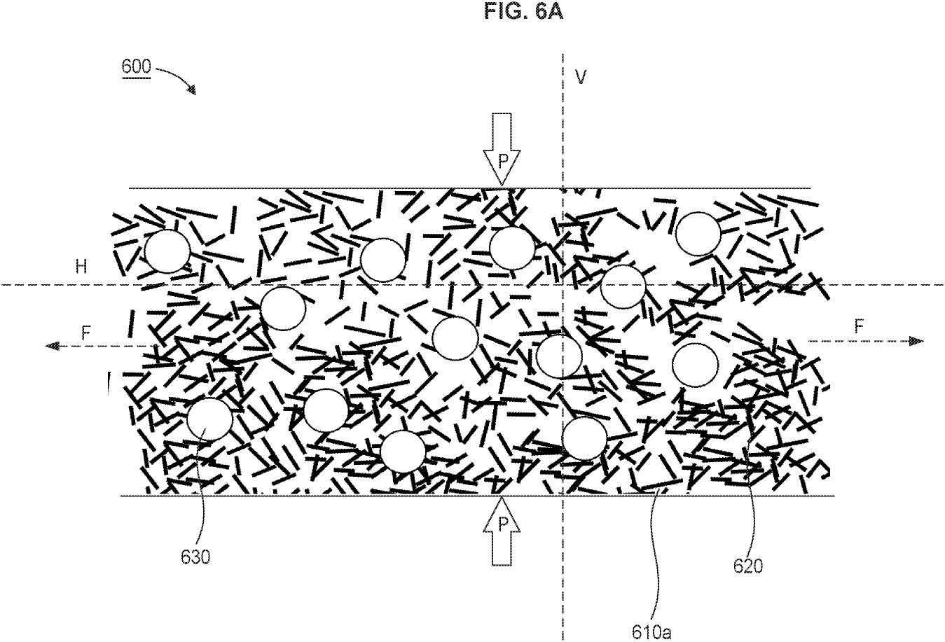

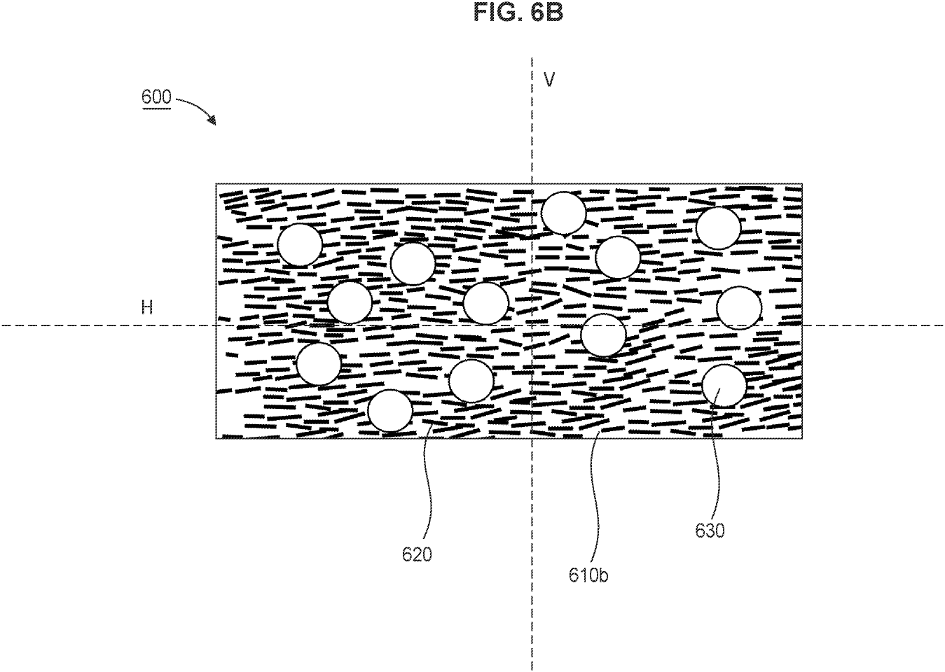

FIGS. 6A-6B illustrate a process of pressing SMC 600, according to an embodiment. FIG. 6A shows the SMC 600 with the various components dispersed therein during the pressing process, while FIG. 6B shows the SMC 600 after being pressed. As shown, the SMC 600 includes a flowing thermoset resin 610a in FIG. 6A and a thermoset matrix 610b in FIG. 6B. The SMC 600 further includes graphene flakes 620 and reinforcement beads 630. In some embodiments, the thermoset matrix 610b, the graphene flakes 620, and the reinforcement beads 630 can be the same or substantially similar to the thermoset matrix 510, the graphene flakes 520, and the reinforcement beads 530, as described above with reference to FIG. 5. Thus, certain aspects of the thermoset matrix 610b, the graphene flakes 620, and the reinforcement beads 630 are not described in greater detail herein.

FIGS. 6A and 6B show a horizontal plane H and a vertical plane V for reference. As shown in FIG. 6A, a pressing force P is imposed on the SMC 600 in a direction perpendicular or substantially perpendicular to the horizontal plane. The pressing force P induces flow of the thermoset resin 610a (and the components dispersed therein) away from a vertical plane V. The thermoset resin 610a flows along the flow lines F. Upon flow of the thermoset resin 610a, the graphene flakes 620 align parallel or substantially parallel with the horizontal plane H, due to the thermodynamic favorability of such an alignment. In other words, the graphene flakes 620 orient themselves to block the flow of the thermoset resin 610a as little as possible. Upon flow of the thermoset resin 610a, the fibers of the reinforcement beads 630 can also align parallel or substantially parallel with the horizontal plane H. The SMC 600 that results from such flow is depicted in FIG. 6B, which shows a significant percentage of the graphene flakes 620 and a significant percentage of the fibers of the reinforcement beads 630 aligned parallel or substantially parallel to the horizontal plane H.

### Comparative Example 1

An SMC plate, Comparative Example 1 (hereinafter “Comp Ex 1”) was produced from an unsaturated polyester resin with fiberglass fibers dispersed therein. The SMC plate included 25 wt% glass fiber and about 30 wt% mineral filler. The resin and the fiberglass fibers were pressed into a plate with a length of 92 cm, a width of 61 cm, and a thickness of 3 mm.

### Example 1

An SMC plate, Example 1 (hereinafter “Ex 1”) was produced from an unsaturated polyester resin with 0.5 wt% graphene flakes, fiberglass fibers (about 25 wt%), and mineral filler (about 30 wt%) dispersed therein. The resin, the graphene flakes, and the fiberglass fibers were pressed into a plate with a length of 92 cm, a width of 61 cm, and a thickness of 3 mm.

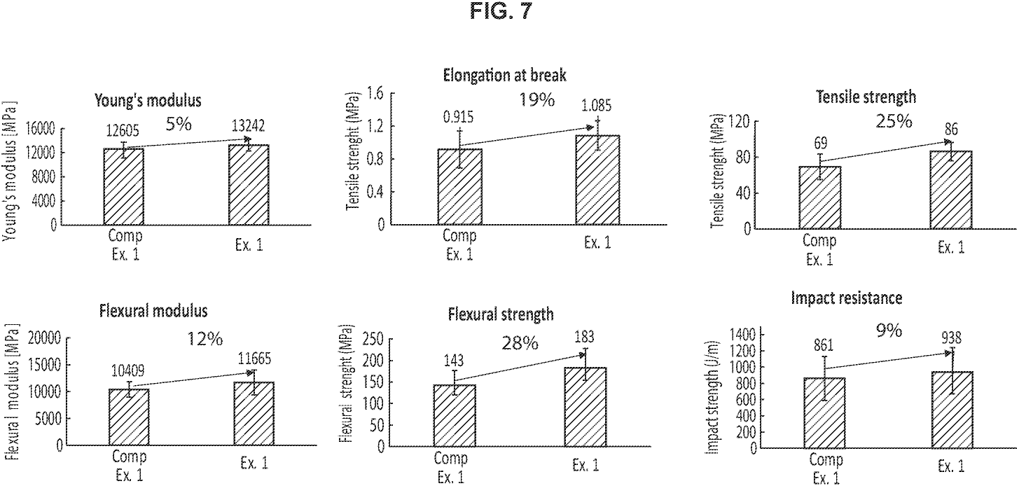

FIG. 7 shows mechanical strength comparisons between samples of the Comp Ex 1 SMC plate and the Ex 1 SMC plate. Specimens were taken from five different zones on each plate, and their properties were averaged across the five zones. Specimens were subject to tensile tests as well as Izod impact strength tests (ISO 180). Specimens were also subject to flexural test. As shown, the Ex 1 SMC plate exhibited a 5% increase in Young’s modulus, a 12% increase in flexural modulus, a 19% increase in elongation at break, a 28% increase in flexural strength, a 25% increase in tensile strength, and a 9% increase in impact resistance, as compared to the Comp Ex 1 SMC plate. Specimens were also subject to water absorption tests (ASTM D570). The absorption after 16 hours of soaking was 2.29% in the Comp Ex 1 specimen and 1.59% in the Ex 1 specimen. This reduced absorption leads to reduced blistering and reduced waviness or warping on the surface of the SMC piece. Blistering, waves, and warping can make the SMC piece difficult to paint.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A composition, comprising:
a thermoset resin;
a plurality of graphene flakes dispersed in the thermoset resin, each of the plurality of graphene flakes having a lateral dimension and a thickness; and
a reinforcement material dispersed in the thermoset resin
wherein at least about 90% of the plurality of graphene flakes are oriented such that the lateral dimension is within about 10 degrees of a parallel alignment with a horizontal plane.

2. The composition of claim 1, wherein the reinforcement material includes at least one of a plurality of fibers or a plurality of beads.

3. The composition of claim 1, wherein at least about 95% of the plurality of graphene flakes are oriented such that the lateral dimension is within about 10 degrees of a parallel alignment with the horizontal plane.

4. The composition of claim 3, wherein at least about 99% of the plurality of graphene flakes are oriented such that the lateral dimension is within about 10 degrees of a parallel alignment with the horizontal plane.

5. The composition of claim 1, wherein the reinforcement material includes a plurality of fibers, the plurality of fibers having a lateral dimension and a thickness and at least about 90% of the plurality of fibers are aligned such that the lateral dimension is within about 10 degrees of a parallel alignment with the horizontal plane.

6. The composition of claim 1, wherein the reinforcement material includes a plurality of fibers, the fibers including at least one of glass fiber, carbon fiber, metallic fibers, polymer fibers, polyester fibers, Kevlar, or nylon.

7. The composition of claim 1, wherein the thermoset resin includes at least one of a polyester resin, a vinyl ester resin, or an epoxy resin.

8. The composition of claim 1, wherein the composition is formed into a slab of material, the slab of material having a thickness of less than about 2 cm.

9. The composition of claim 8, wherein the slab of material has a tensile strength of at least about 64 MPa.

10. The composition of claim 1, wherein the thermoset resin includes a mineral filler.

11. The composition of claim 10, wherein the mineral filler includes CaCO₃.

12. The composition of claim 1, wherein the thermoset resin includes at least one of a mold release agent or a low profile additive.

13. The composition of claim 12, wherein the mold release agent includes at least one of a fatty acid salt or a stearate of a metal ion.

14. The composition of claim 1, wherein the reinforcement material includes a plurality of beads, the plurality of beads including glass beads comprising borosilicates.

15. The composition of claim 14, wherein the glass beads are hollow and have a wall thickness of about 1 µm to about 2 µm.

16. A method, comprising:
mixing a thermoset resin with a plurality of graphene flakes and a reinforcement material, the graphene flakes having a lateral dimension and a thickness, the mixing forming a slab of composite material, the slab of composite material having a first shape;
placing the slab of composite material onto a platform; and
pressing the slab of composite material to form the slab of composite material into a second shape, the second shape different from the first shape,
wherein the pressing forces the composite material to move through a pathway that is sufficiently narrow such that at least about 90% of the graphene flakes become aligned with the lateral dimension within about 10 degrees of a horizontal plane.

17. The method of claim 16, wherein the reinforcement material includes at least one of a plurality of fibers or a plurality of beads.

18. The method of claim 16, wherein at least about 95% of the graphene flakes become aligned with the lateral dimension within about 10 degrees of a horizontal plane.

19. The method of claim 18, wherein at least about 99% of the graphene flakes become aligned with the lateral dimension within about 10 degrees of a horizontal plane.

20. The method of claim 16, wherein the pathway has a thickness of less than about 2 cm.

21. The method of claim 20, wherein the pathway has a thickness of less than about 1 cm.

22. The method of claim 16, wherein the slab of composite material is a first slab of material, the method further comprising:
placing a second slab of composite material onto the first slab of composite material.

23. The method of claim 16, further comprising:
cutting the slab of composite material from a roll of composite material.

24. An article, comprising:
a thermoset resin;
a plurality of graphene flakes dispersed in the thermoset resin, each of the plurality of graphene flakes having a lateral dimension and a thickness; and
a reinforcement material dispersed in the thermoset resin, the reinforcement material configured to enhance mechanical stability of the sheet of material,
wherein at least about 90% of the plurality of graphene flakes are oriented such that the lateral dimension is within about 10 degrees of a parallel alignment with a bottom surface of the article.

25. The article of claim 24, wherein the article is substantially planar.

26. The article of claim 24, wherein article of material has a tensile strength of at least about 64 MPa.
